(19) United States
(12) Patent Application Publication
(10) Pub. No.: US 2015/0202713 A1
(43) Pub. Date: Jul. 23, 2015

(54) METHOD FOR MANAGING QUALITY OF LASER CLADDING PROCESSING, AND LASER CLADDING PROCESSING DEVICE

(71) Applicant: TOYOTA JIDOSHA KABUSHIKI KAISHA, Toyota-shi (JP)

(72) Inventor: Kohei YANAKA, Nisshin-shi (JP)

(21) Appl. No.: 14/575,279

(22) Filed: Dec. 18, 2014

(30) Foreign Application Priority Data
Jan. 17, 2014 (JP) 2014-006778

(51) Int. Cl. B23K 26/03; B23K 26/34; B23K 26/14

(52) U.S. Cl. CPC B23K 26/032; B23K 26/1411; B23K 26/34

(57) ABSTRACT

Provided are a method for managing the quality of laser cladding processing and a laser cladding processing device by which the quality of a cladding layer formed on a processing portion of a workpiece can be managed by a simple configuration and reliably while suppressing manufacturing cost. The quality of the cladding layer is managed based on the intensity of infrared light S generated when metal powder P discharged toward laser beam R is melted in the air by the laser beam R.

### BACKGROUND

1. Technical Field

The present invention relates to a method for managing quality of laser cladding processing, and a laser cladding processing device.

2. Background Art

Conventionally, laser processing is known whereby, in order to increase the durability of a valve seat of an engine cylinder head while increasing its design freedom, the valve seat is irradiated with laser beam while a powder (powdered) overlay material is supplied to the valve seat, forming an overlay layer (cladding layer) while the valve seat and the laser beam are relatively rotated. Specifically, the cylinder head that has been subjected to a machining process required for the engine combustion chamber, such as a valve opening forming process, is irradiated with laser beam while an area of the cylinder head that is to be formed into the valve seat is supplied with the powdered overlay material, which may include a copper alloy and the like having abrasion resistance. In this way, a ring-shaped overlay layer, namely an overlay bead portion, that is to eventually provide the valve seat, is formed. Generally, the technology is referred to as laser cladding processing.

Known examples of the method for managing the quality of the overlay layer (cladding layer) formed by such laser cladding processing include a method involving brightness measurement, a method involving radiation temperature measurement, and a method involving shape measurement using image processing. These types of conventional technology are disclosed in Patent Documents 1 and 2.

In the cladding layer quality determination method according to Patent Document 1, the light-receiving portion of a luminance meter is aimed at the molten pool of a cladding layer, and the quality of the cladding layer is determined based on a change in a measurement signal obtained from the brightness measured in a measurement spot having a predetermined size and set for a predetermined position of the molten pool.

In the method for ensuring the quality of an overlay item according to Patent Document 2, the presence or absence of abnormality in an overlay-processed item is determined by observing optical intensity using a plurality of optical sensors provided with a condensing optical system. The condensing optical system narrows the light generated from the molten pool, which is formed at the irradiated point as the member surface and the overlay material are melted during irradiation by a localized heating source, to the size of the molten pool or smaller.

### RELATED ART DOCUMENTS

### Patent Documents

Patent Document 1: JP 2002-48718 A

Patent Document 2: JP 9-192861 A

### SUMMARY

By the cladding layer quality determination method according to Patent Document 1, the problem of measuring the brightness of a portion that is not melted or the overlay material being dropped and supplied onto the base material can be almost eliminated, and variation in the measurement signal obtained on the basis of the measured brightness can be decreased. Thus, even when the change caused in the molten pool at the laser cladding processing point is not noticeable, the quality of the cladding layer can be determined.

By the method for ensuring the quality of the overlay item according to Patent Document 2, the presence or absence of abnormality during the overlay processing can be determined online by observing optical intensity using the plurality of optical sensors provided with the condensing optical system that narrows the light generated from the molten pool, which is formed at the irradiated point by the melting of the member surface and the overlay material during irradiation by the localized heating source, to the size of the molten pool or smaller.

However, by the methods according to Patent Documents 1 and 2, the quality of the cladding layer is determined online or the presence of abnormality during overlay processing is detected while the cladding layer is being formed on the processing portion of the workpiece. Thus, the product having inferior quality, once fabricated, has to be wasted, possibly creating the problem of an increase in product manufacturing cost. Further, the brightness or optical intensity of light generated from the molten pool may vary depending on the composition and the like of the workpiece. Thus, there is the likelihood that the quality of the cladding layer being formed on the processing portion of the workpiece, or the development of abnormality during overlay processing cannot be sensitively detected.

The present invention was made in view of the above problems, and an object of the present invention is to provide a method for managing the quality of laser cladding processing and a laser cladding processing device by which the quality of a cladding layer formed on a processing portion of a workpiece can be managed by a simple configuration and reliably while suppressing manufacturing cost.

In order to achieve the object, the present inventors conducted extensive research and, as a result, determined that the quality of the cladding layer can be managed without actually forming a cladding layer on the processing portion of the workpiece, by measuring the intensity of infrared light (the amount of infrared) generated when metal powder being discharged toward laser beam is melted in the air by the laser beam.

The present invention provides a method for managing the quality of laser cladding processing where a cladding layer is formed on a processing portion of a workpiece by melting metal powder which is discharged toward laser beam irradiating the processing portion of the workpiece and which is supplied to the processing portion of the workpiece. The method includes managing the quality of the cladding layer based on an intensity of infrared light generated from the metal powder when the metal powder being discharged toward the laser beam is melted in the air by the laser beam.

According to the quality management method, the quality of the cladding layer is managed based on the intensity of the infrared light generated when the metal powder being discharged toward the laser beam is melted in the air by the laser beam. Thus, without actually forming a cladding layer on the processing portion of the workpiece, the quality of the cladding layer formed on the processing portion of the workpiece can be managed. Accordingly, the workpiece manufacturing cost can be suppressed, and the quality of the cladding layer formed on the processing portion of the workpiece can be sensitively and reliably determined.

Preferably, the metal powder may be discharged toward the laser beam from around the laser beam.

According to the above quality management method, the metal powder is discharged toward the laser beam from around the laser beam, whereby the metal powder discharged from around the laser beam collides on the irradiation axis of the laser beam, and the metal powder melted by the laser beam can be present on the irradiation axis of the laser beam. Thus, the intensity of the infrared light used for managing the quality of the cladding layer can be increased, so that the quality of the cladding layer formed on the processing portion of the workpiece can be more sensitively and reliably determined.

Preferably, the quality of the cladding layer may be managed based on the intensity of the infrared light generated in an irradiation axis direction of the laser beam.

According to the above quality management method, the quality of the cladding layer is managed by measuring the intensity of the infrared light generated in the irradiation axis direction of the laser beam. Thus, regardless of the shape of the workpiece, particularly the shape thereof around the processing portion, the intensity of the infrared light generated from the metal powder melted in the air by the laser beam can be reliably measured. Accordingly, the quality of the cladding layer formed on the processing portion of the workpiece can be even more sensitively and reliably determined. Further, the path of the infrared light used for managing the quality of the cladding layer and the laser beam path can be made common, whereby the configuration of the laser cladding processing device used for laser cladding processing can be simplified.

The present invention also provides a laser cladding processing device for forming a cladding layer on a processing portion of a workpiece by melting metal powder which is discharged toward laser beam irradiating the processing portion of the workpiece and which is supplied to the processing portion of the workpiece. The laser cladding processing device includes a measurement unit that measures an intensity of infrared light generated from the metal powder when the metal powder being discharged toward the laser beam is melted in the air by the laser beam; and a processing unit that manages the quality of the cladding layer by processing the intensity of the infrared light measured by the measurement unit.

The laser cladding processing device is provided with the measurement unit that measures the intensity of the infrared light generated when the metal powder discharged toward the laser beam is melted in the air by the laser beam, and the processing unit that manages the quality of the cladding layer based on the intensity of the infrared light measured by the measurement unit. Thus, the quality of the cladding layer formed on the processing portion of the workpiece can be managed without actually forming a cladding layer on the processing portion of the workpiece. Accordingly, the workpiece manufacturing cost can be suppressed, and the quality of the cladding layer formed on the processing portion of the workpiece can be sensitively and reliably determined.

As will be understood from the foregoing description, according to the present invention, the quality of the cladding layer is managed based on the intensity of the infrared light generated when the metal powder discharged toward the laser beam is melted in the air by the laser beam. By this simple configuration, the quality of the cladding layer fowled on the processing portion of the workpiece can be reliably managed without actually forming a cladding layer on the processing portion of the workpiece.

### BRIEF DESCRIPTION OF THE DRAWINGS

FIG. 1 is a perspective view illustrating an overall configuration of a laser cladding processing device according to the present invention.

FIG. 2 is a diagram schematically illustrating a quality management method using the laser cladding processing device of FIG. 1.

FIG. 3 illustrates an example of infrared light intensity displayed by a management device illustrated in FIG. 2.

### DETAILED DESCRIPTION OF THE EMBODIMENTS

In the following, an embodiment of a quality management method for laser cladding processing by the present invention and a laser cladding processing device will be described with reference to the drawings.

### {Laser Cladding Processing Device}

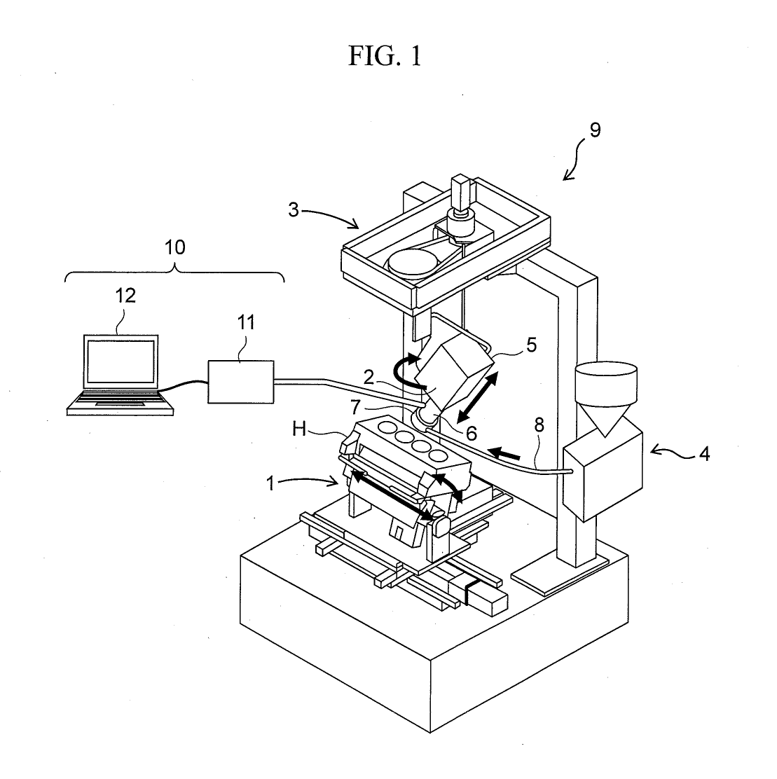

FIG. 1 is a perspective view illustrating the overall configuration of a laser cladding processing device according to the present invention.

The laser cladding processing device 9 is a device that performs laser cladding processing on a valve seat portion (processing portion) of a cylinder head (workpiece) H, for example. The laser cladding processing device 9 mainly includes a cylinder head holder device 1 that tilts and holds the cylinder head H; a laser processing head 2 that discharges powder metal (such as a material having copper or nickel as a principal component) while irradiating the processing portion with laser beam; a rotating device 3 that rotates the laser processing head 2 about a vertical axis while holding the head at an angle with respect to the vertical direction; and a powder metal supply device (feeder) 4 that supplies the powder metal to the laser processing head 2.

The cylinder head holder device 1 is configured to tilt the cylinder head H so as to align the central axis of the valve seat portion with the vertical direction, or to two-dimensionally move the cylinder head H in the horizontal direction so as to align the central axis of the valve seat portion with the rotating axis of the laser processing head 2.

The laser processing head 2 includes a laser generation portion 5 that generates laser beam, an optical system portion 6 housing a condensing lens and the like for condensing the laser beam, and a coaxial nozzle 7 of double pipe structure configured to pass the laser beam while discharging powder metal from around the laser beam. The coaxial nozzle 7 is connected to the feeder 4 via a supply pipe 8. In the laser cladding processing device 9, an amount of powder metal corresponding to the overlay layer (cladding layer) to be formed on the processing portion is supplied from the feeder 4 to the coaxial nozzle 7, and the laser generation portion 5 generates laser beam of an output corresponding to the powder metal. The powder metal is discharged via the coaxial nozzle 7 while the processing portion is irradiated with laser beam so that a desired cladding layer can be formed on the valve seat portion of the cylinder head H.

In the illustrated laser cladding processing device 9, a management device 10 for managing the quality of the cladding layer formed on the valve seat portion of the cylinder head H, for example, is disposed.

The management device 10 mainly includes a radiation thermometer (measurement unit) 11 that measures the intensity of infrared light (the amount of infrared) generated when the metal powder discharged toward the laser beam is melted in the air by the laser beam, and a signal processing device (processing unit) 12 that processes the intensity of the infrared light measured by the radiation thermometer 11 so as to manage the quality of the cladding layer.

### {Quality Management Method for Laser Cladding Processing}

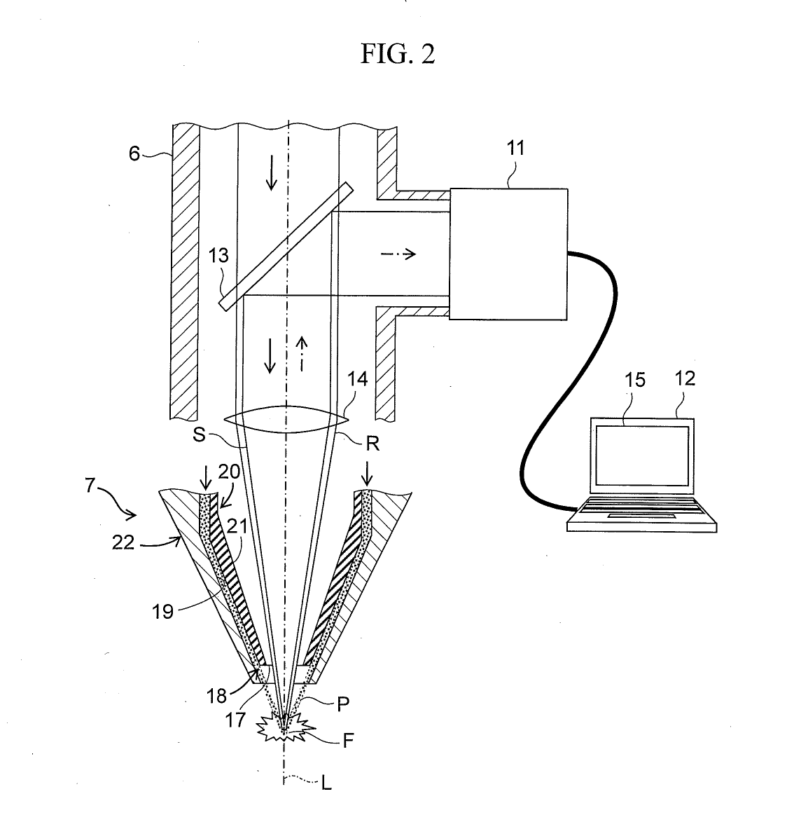

With reference to FIG. 2, a quality management method using the management device 10 of the laser cladding processing device 9 illustrated in FIG. 1 will be described. The management device 10 is mainly used for determining the quality of the cladding layer formed on the processing portion of the workpiece before laser cladding processing is performed at the processing portion of the workpiece.

The device configuration of the laser cladding processing device 9 will be described in greater detail. The coaxial nozzle 7 mainly includes a generally circular pipe-shaped inner nozzle 20 with a laser passage 21 for passing laser beam R, and an outer nozzle 22 externally fitted on the inner nozzle 20, as illustrated in FIG. 2. The inner nozzle 20 and the outer nozzle 22 are coaxially disposed, with a generally circular ring-shaped discharge space 19 defined between the inner nozzle 20 and the outer nozzle 22 for passing metal powder P supplied from the feeder 4 to the coaxial nozzle 7. The discharge space 19 has decreasing diameter toward the tip side of the coaxial nozzle 7. The metal powder P is discharged out of a discharge opening 18 via the discharge space 19. The discharge space 19 is configured such that the metal powder P is generally uniformly discharged, together with a carrier gas (such as nitrogen gas), toward an irradiation point F on an irradiation axis L of the laser beam R or the vicinity thereof, from around the laser beam R.

In the optical system portion 6, a beam splitter (spectral unit) 13, which may include a dielectric multi-layer mirror and the like, and a condensing lens 14 are disposed next to each other on the irradiation axis L of the laser beam R. The laser beam R generated by the laser generation portion 5 passes through the beam splitter 13 contained in the optical system portion 6, and is condensed by the condensing lens 14. The laser beam R then passes through the laser passage 21 of the inner nozzle 20 of the coaxial nozzle 7 and irradiates the irradiation point F set externally of the coaxial nozzle 7 via an irradiation opening 17. Thus, the laser beam R that has passed through the irradiation opening 17 irradiates the metal powder P discharged from the discharge opening 18 at the irradiation point F or the vicinity thereof.

A quality management method using the management device 10 of the laser cladding processing device 9 will be described. The laser cladding processing device 9 is operated with no workpiece present in the vicinity of the irradiation point F of the laser beam R. The metal powder P is supplied from the feeder 4 to the coaxial nozzle 7, and the laser beam R is generated by the laser generation portion 5. While the laser beam R is irradiated via the coaxial nozzle 7, the powder metal P is discharged from the discharge opening 18, whereby the metal powder P is melted by the laser beam R in the air in the vicinity of the irradiation point F on the irradiation axis L of the laser beam R, and infrared light S is generated from the molten metal powder P. The infrared light S generated from the metal powder P melted in the air in the vicinity of the irradiation point F passes through the laser passage 21 of the inner nozzle 20 (in the opposite direction from the direction of laser beam R irradiation) and reaches the beam splitter (spectral unit) 13 through the condensing lens 14 of the optical system portion 6. The beam splitter 13 reflects a measurement wavelength component of the infrared light S in a predetermined direction (vertical with respect to the laser beam R irradiation direction in the figure), thus separating from the laser beam R. The infrared light S separated by the beam splitter 13 (particularly the measurement wavelength component thereof) is introduced into the radiation thermometer 11, where the intensity of the light (the amount of infrared) is measured. The intensity measured by the radiation thermometer 11 (the amount of infrared) is transmitted to the signal processing device 12. The signal processing device 12 performs predetermined signal processing, and the result of the processing is displayed on a display screen 15 of the signal processing device 12.

A user, for example, confirms the processing result via the display screen 15 of the signal processing device 12, and determines, based on the processing result, the appropriateness of the amount of discharge of the metal powder P discharged from the discharge opening 18 in the vicinity of the irradiation point F, and the appropriateness of the intensity of the laser beam R irradiated from the irradiation opening 14 to the irradiation point F. Thus, the quality of the cladding layer formed on the processing portion of the workpiece can be determined before laser cladding processing is performed at the processing portion of the workpiece, for example. The appropriateness of the amount of discharge of the metal powder P, and the appropriateness of the intensity of the laser beam R can be determined by, e.g., comparing the intensity of the infrared light S actually measured with the previously measured intensity (master waveform) of the infrared light S in a good item.

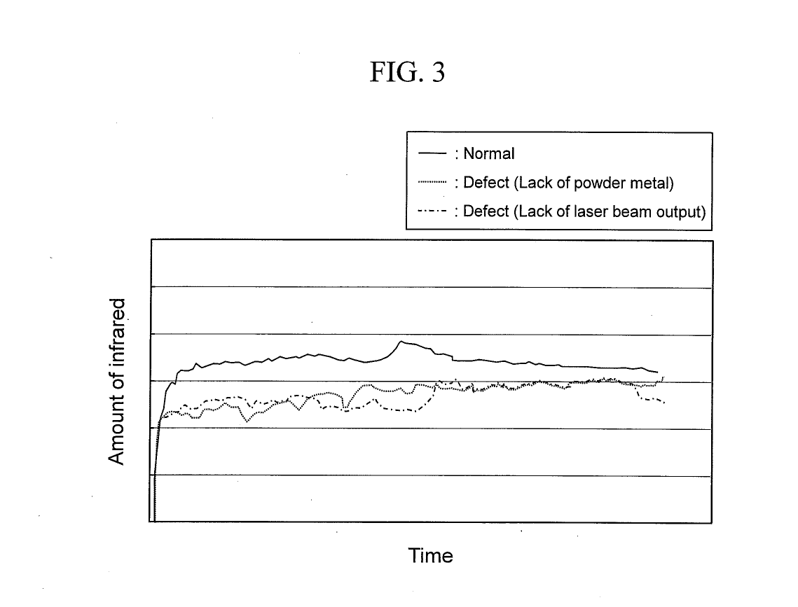

In practice, various parameters in the laser cladding processing device 9 are set in advance so that an amount of powder metal corresponding to the cladding layer formed on the processing portion of the workpiece can be supplied from the feeder 4 to the coaxial nozzle 7, and so that laser beam of an output corresponding to the powder metal can be generated by the laser generation portion 5. Thus, when a defect is caused in terms of the amount of discharge of the metal powder P or the intensity of the laser beam R (such as when clogging of the metal powder P occurs in the coaxial nozzle 7, or when a lens in the optical system portion 6 is contaminated), the intensity of the infrared light S (the amount of infrared) generated from the powder metal P melted in the air is relatively decreased, as shown in FIG. 3. When the actually measured intensity of the infrared light S is lower than a predetermined determine reference, as shown in FIG. 3, the user, for example, can determine that the quality of the cladding layer will be decreased by a decrease in the amount of discharge of the metal powder P or in the intensity of the laser beam R. Thus, the quality of the cladding layer formed on the processing portion can be relatively easily determined

The management device 10 may be used while laser cladding processing is being performed at the processing portion of the workpiece. For example, the intensity of the infrared light generated from the molten pool as it is formed at the processing portion when the powder metal is discharged while the processing portion is irradiated with the laser beam via the coaxial nozzle 7 is measured by the radiation thermometer 11, the intensity of the infrared light measured by the radiation thermometer 11 is subjected to predetermined signal processing in the signal processing device 12, and the quality of the cladding layer formed on the processing portion is determined from the result of the processing. Generally, the reference for determination used when the quality of the cladding layer is determined while laser cladding processing is being performed at the processing portion of the workpiece is different from the determination reference used when the quality of the cladding layer is determined prior to performing the laser cladding processing as described above.

Thus, according to the present embodiment, the quality of the cladding layer is managed based on the intensity of the infrared light S generated when the metal powder P discharged toward the laser beam R is melted in the air by the laser beam R. In this way, the quality of the cladding layer formed on the processing portion of the workpiece can be managed without actually forming the cladding layer on the processing portion of the workpiece. Accordingly, the workpiece manufacturing cost can be suppressed, and the quality of the cladding layer formed on the processing portion of the workpiece can be sensitively and reliably determined.

In the foregoing embodiment, in order to more sensitively and reliably determine the quality of the cladding layer formed on the processing portion of the workpiece by increasing the intensity of the infrared light S (the amount of infrared) used for managing the quality of the cladding layer, the metal powder P is generally uniformly discharged, via the coaxial nozzle 7, from around the laser beam R toward the laser beam R. However, as long as the intensity of the infrared light S (the amount of infrared) can be measured by the radiation thermometer 11, it is not necessarily required to discharge the metal powder P generally uniformly from around the laser beam R toward the laser beam R.

In the foregoing embodiment, in order to simplify the configuration of the laser cladding processing device 9 while reliably measuring the intensity of the infrared light S generated from the metal powder P melted in the air by the laser beam R, the intensity of the infrared light S generated in the direction of the irradiation axis L of the laser beam R is measured for managing the quality of the cladding layer. However, obviously, the intensity of the infrared light S generated from the metal powder P melted in the air by the laser beam R may be measured from any direction.

While the embodiment of the present invention has been described with reference to the drawings, it should be noted that the specific configuration is not limited to the embodiment, and that design modifications and the like within the scope or spirit of the present invention are included in the present invention.

### DESCRIPTION OF SYMBOLS

1 Cylinder head holder device
2 Laser processing head
3 Rotation device
4 Powder metal supply device (feeder)
5 Laser generation portion
6 Optical system portion
7 Coaxial nozzle
8 Supply pipe
9 Laser cladding processing device
10 Management device
11 Radiation thermometer (measurement unit)
12 Signal processing device (processing unit)
13 Beam splitter (spectral unit)
14 Condensing lens
15 Display screen
16 Irradiation opening
17 Discharge opening
18 Discharge space
19 Inner nozzle
20 Laser passage
21 Outer nozzle
F Laser beam irradiation point
L Laser beam irradiation axis
P Metal powder
R Laser beam

1. A method for managing the quality of laser cladding processing where a cladding layer is formed on a processing portion of a workpiece by melting metal powder which is discharged toward laser beam irradiating the processing portion of the workpiece and which is supplied to the processing portion of the workpiece,
the method comprising managing the quality of the cladding layer based on an intensity of infrared light generated from the metal powder when the metal powder being discharged toward the laser beam is melted in the air by the laser beam.

2. The method for managing the quality of laser cladding processing according to claim 1, wherein the metal powder is discharged toward the laser beam from around the laser beam.

3. The method for managing the quality of laser cladding processing according to claim 1, wherein the quality of the cladding layer is managed based on the intensity of the infrared light generated in an irradiation axis direction of the laser beam.

4. A laser cladding processing device for forming a cladding layer on a processing portion of a workpiece by melting metal powder which is discharged toward laser beam irradiating the processing portion of the workpiece and which is supplied to the processing portion of the workpiece,
the laser cladding processing device comprising:
a measurement unit that measures an intensity of infrared light generated from the metal powder when the metal powder being discharged toward the laser beam is melted in the air by the laser beam; and
a processing unit that manages the quality of the cladding layer by processing the intensity of the infrared light measured by the measurement unit.

5. The laser cladding processing device according to claim 4, wherein the metal powder is discharged toward the laser beam from around the laser beam.

6. The laser cladding processing device according to claim 4, wherein the measurement unit is configured to measure the intensity of the infrared light generated in an irradiation axis direction of the laser beam.

7. The laser cladding processing device according to claim 6, comprising a spectral unit disposed on the irradiation axis of the laser beam and configured to transmit the laser beam while reflecting the infrared light.

8. The method for managing the quality of laser cladding processing according to claim 2, wherein the quality of the cladding layer is managed based on the intensity of the infrared light generated in an irradiation axis direction of the laser beam.

9. The laser cladding processing device according to claim 5, wherein the measurement unit is configured to measure the intensity of the infrared light generated in an irradiation axis direction of the laser beam.
